(19) United States
(12) Patent Application Publication
(10) Pub. No.: US 2023/0252376 A1
(43) Pub. Date: Aug. 10, 2023

(54) INFORMATION PROCESSING APPARATUS AND INFORMATION PROCESSING METHOD

(71) Applicant: Toyota Jidosha Kabushiki Kaisha, Toyota-shi (JP)

(72) Inventors: Mitsuhiro Miura, Nagoya-shi (JP); Kenichi Yamada, Nisshin-shi (JP); Satoshi Komamine, Nagoya-shi (JP); Fumiyuki Kagara, Sagamihara-shi (JP); Go Tanaka, Toyota-shi (JP); Hiroyuki Nishizawa, Tokyo-to (JP)

(73) Assignee: Toyota Jidosha Kabushiki Kaisha, Toyota-shi (JP)

(21) Appl. No.: 18/166,939

(22) Filed: Feb. 9, 2023

(30) Foreign Application Priority Data
Feb. 10, 2022 (JP) 2022-019791

(51) Int. Cl. G06Q 10/0631; G06Q 10/087

(52) U.S. Cl. CPC G06Q 10/063114; G06Q 10/087

(57) ABSTRACT

An information processing apparatus includes a controller. The controller is configured to acquire information on a scheduled time for loading an article onto a vehicle. The controller is configured to acquire a predicted number of passengers on the vehicle at the scheduled time. The controller is configured to determine whether the vehicle has space for the article at the scheduled time.

### CROSS-REFERENCE TO RELATED APPLICATION

This application claims priority to Japanese Patent Application No. 2022-019791 filed on Feb. 10, 2022, the entire contents of which are incorporated herein by reference.

### TECHNICAL FIELD

The present disclosure relates to an information processing apparatus and an information processing method.

### BACKGROUND

Technology for freight and passenger consolidation is known. For example, Patent Literature (PTL) 1 discloses an information processing apparatus that manages operations of autonomous vehicles with loading space for luggage.

### CITATION LIST

### Patent Literature

PTL 1: JP 2020-149576 A

### SUMMARY

There is room for improvement with respect to efficient transport of articles.

It would be helpful to provide technology for efficient transport of articles.

An information processing apparatus according to an embodiment of the present disclosure includes a controller configured to:

acquire information on a scheduled time for loading an article onto a vehicle;

acquire the predicted number of passengers on the vehicle at the scheduled time; and

determine whether the vehicle has space for the article at the scheduled time.

An information processing method according to an embodiment of the present disclosure includes:

acquiring information on a scheduled time for loading an article onto a vehicle;

acquiring the predicted number of passengers on the vehicle at the scheduled time; and

determining whether the vehicle has space for the article at the scheduled time.

According to an embodiment of the present disclosure, it is possible to provide technology for efficient transport of articles.

### BRIEF DESCRIPTION OF THE DRAWINGS

In the accompanying drawings:

FIG. 1 is a diagram illustrating a schematic configuration of an information processing system according to an embodiment of the present disclosure;

FIG. 2 is a block diagram of the information processing system illustrated in FIG. 1; and

FIG. 3 is a flowchart illustrating operations of an information processing apparatus illustrated in FIG. 2.

### DETAILED DESCRIPTION

An embodiment of the present disclosure will be described below, with reference to the drawings.

(Configuration of Information Processing System)

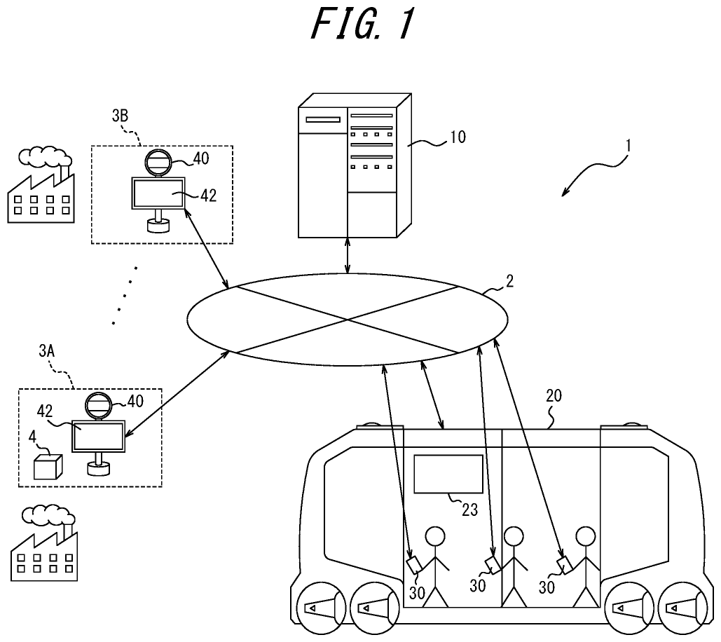

As illustrated in FIG. 1, an information processing system 1 includes at least one information processing apparatus 10, at least one vehicle 20, one or more terminal apparatuses 30, and one or more output apparatuses 40. However, the information processing system 1 may not include the multiple terminal apparatuses 30 and/or the multiple output apparatuses 40. The information processing system 1 should include at least one information processing apparatus 10, at least one vehicle 20, at least one terminal apparatus 30, and at least one output apparatus 40. The information processing system 1 does not always include the terminal apparatus 30 and the output apparatus 40.

The information processing apparatus 10, the vehicle 20, the terminal apparatuses 30, and the output apparatuses 40 are communicable via a network 2. The network 2 may be any network including a mobile communication network, the Internet, or the like.

The information processing apparatus 10, for example, manages operations of the vehicle 20. The information processing apparatus 10 is, for example, a dedicated computer configured to function as a server, a general purpose personal computer, a cloud computing system, or the like.

The vehicle 20 travels within a predetermined site. The site has factories. However, the vehicle 20 may travel anywhere other than within the site. In the present embodiment, the vehicle 20 circulates a predetermined route in the site. The route that the vehicle 20 circulates includes one or more stops, for example. For example, the route that the vehicle 20 circulates includes stops 3A and 3B. However, the route that the vehicle 20 circulates may not include the multiple stops. The route that the vehicle 20 circulates should include at least one stop.

The vehicle 20 is capable of performing freight and passenger consolidation. In other words, the vehicle 20 can transport users and articles together. The users who ride on the vehicle 20 are, for example, workers at the factories in the site. The users commute to the factories by the vehicle 20. The users get on the vehicle 20 at the stops, and get off the vehicle 20 at the stops. The articles to be transported by the vehicle 20 are, for example, parts used in the factories, parts produced in the factories, or the like. The articles are loaded onto the vehicle 20 at the stops, and unloaded from the vehicle 20 at the stops.

In the present embodiment, the vehicle 20 transports an article 4. The article 4 is loaded onto the vehicle 20 at the stop 3A. The article 4 is unloaded from the vehicle 20 at the stop 3B. In other words, the vehicle 20 transports the article 4 from the stop 3A to the stop 3B.

The vehicle 20 may be any type of automobile. The vehicle 20 is, for example, a gasoline automobile, a battery electric vehicle (BEV), a hybrid electric vehicle (HEV), a plug-in hybrid electric vehicle (PHEV), a fuel cell electric vehicle (FCEV), or the like. The vehicle 20 may be driven by a driver. The driving of the vehicle 20 may be partly automated at any level. The level of automation is, for example, one of level 1 to level 5 according to the classification of the Society of Automotive Engineers (SAE). The vehicle 20 may be a dedicated Mobility as a Service (MaaS) vehicle.

The terminal apparatuses 30 are used by the users. For example, the users are each in possession of the terminal apparatus 30 and ride on the vehicle 20. Each of the terminal apparatuses 30 is, for example, a mobile phone, a smartphone, a tablet, a personal computer (PC), or the like.

The output apparatuses 40 are located at the stops on the route that the vehicle 20 circulates. Each of the output apparatuses 40 is, for example, a digital signage or the like.

<Configuration of Information Processing Apparatus>

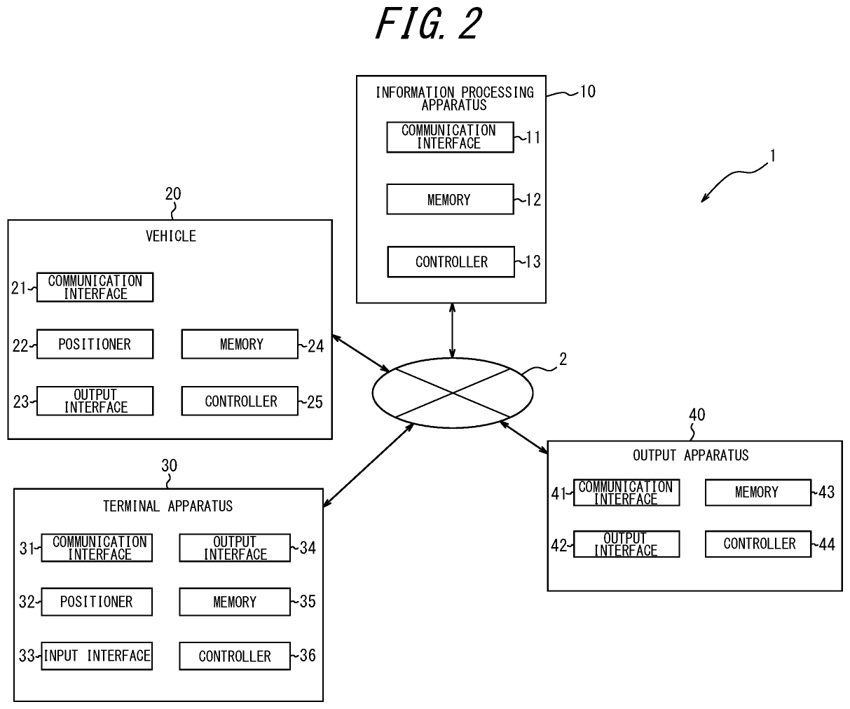

As illustrated in FIG. 2, the information processing apparatus 10 includes a communication interface 11, a memory 12, and a controller 13.

The communication interface 11 is configured to include at least one communication module for connection to the network 2. For example, the communication module is a communication module compliant with a standard such as a wired Local Area Network (LAN) or a wireless LAN. However, the communication module is not limited to this. The communication module may be compliant with any communication standard. The communication interface 11 is connectable to the network 2 via a wired LAN or a wireless LAN using the communication module.

The memory 12 is configured to include at least one semiconductor memory, at least one magnetic memory, at least one optical memory, or a combination of at least two of these. The semiconductor memory is, for example, random access memory (RAM), read only memory (ROM), or the like. The RAM is, for example, static random access memory (SRAM), dynamic random access memory (DRAM), or the like. The ROM is, for example, electrically erasable programmable read only memory (EEPROM) or the like. The memory 12 may function as a main memory, an auxiliary memory, a cache memory, or the like. The memory 12 stores data to be used in operations of the information processing apparatus 10 and data obtained by the operations of the information processing apparatus 10.

The controller 13 is configured to include at least one processor, at least one dedicated circuit, or a combination thereof. The processor is, for example, a general purpose processor such as a central processing unit (CPU) or a graphics processing unit (GPU), or a dedicated processor that is dedicated to specific processing. The dedicated circuit is, for example, a field-programmable gate array (FPGA), an application specific integrated circuit (ASIC), or the like. The controller 13 executes processes related to the operations of the information processing apparatus 10 while controlling the components of the information processing apparatus 10.

The functions of the information processing apparatus 10 may be implemented by executing a processing program according to the present embodiment by a processor corresponding to the controller 13. That is, the functions of the information processing apparatus 10 may be implemented by software. The processing program enables a computer to function as the information processing apparatus 10 by causing the computer to execute the operations of the information processing apparatus 10. That is, the computer functions as the information processing apparatus 10, by executing the operations of the information processing apparatus 10 in accordance with the processing program.

Some or all of the functions of the information processing apparatus 10 may be realized by a dedicated circuit corresponding to the controller 13. That is, some or all of the functions of the information processing apparatus 10 may be realized by hardware.

The controller 13 can control the communication interface 11 to receive, from the vehicle 20 via the network 2, positional information on the vehicle 20. The controller 13 may control the memory 12 to store the received positional information on the vehicle 20, in association with a time at which the positional information on the vehicle 20 is received. The controller 13 can control the communication interface 11 to receive, from each of the terminal apparatuses 30 via the network 2, positional information on the terminal apparatus 30 and identification information on the user. The controller 13 may control the memory 12 to store the received positional information on the terminal apparatus 30 and the identification information on the user, in association with a time at which the positional information on the terminal apparatus 30 and the like are received.

<Configuration of Vehicle>

As illustrated in FIG. 2, the vehicle 20 includes a communication interface 21, a positioner 22, an output interface 23, a memory 24, and a controller 25.

The communication interface 21 is configured to include at least one communication module for connection to the network 2. The communication module is, for example, a communication module compliant with a mobile communication standard such as Long Term Evolution (LTE), 4th Generation (4G), or 5th Generation (5G). However, the communication module is not limited to this. The communication module may be compliant with any communication standard.

The communication interface 21 may be further configured to include a communication module capable of performing short-range wireless communication. The communication module is, for example, a communication module compliant with a short-range wireless communication standard such as Wi-Fi® (Wi-Fi is a registered trademark in Japan, other countries, or both) or Bluetooth® (Bluetooth is a registered trademark in Japan, other countries, or both).

The positioner 22 is capable of acquiring positional information on the vehicle 20. The positioner 22 is configured to include at least one receiving module corresponding to a satellite positioning system. The receiving module is, for example, a receiving module corresponding to the Global Positioning System (GPS). However, the receiving module is not limited to this. The receiving module may be a receiving module corresponding to any satellite positioning system.

The output interface 23 can output data. The output interface 23 is configured to include at least one interface for output that is capable of outputting data. The interface for output is, for example, a display, a speaker, or the like. The display is, for example, a liquid crystal display (LCD), an organic electro luminescent (EL) display, or the like. In FIG. 1, the output interface 23 is illustrated as a display. However, the interface for output is not limited to this.

The memory 24 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 24 may function as a main memory, an auxiliary memory, or a cache memory. The memory 24 stores data to be used for operations of the vehicle 20 and data obtained by the operations of the vehicle 20.

The controller 25 is configured to include at least one processor, at least one dedicated circuit, or a combination thereof. The processor is, for example, a general purpose processor such as a CPU or a GPU, or a dedicated processor that is dedicated to specific processing The dedicated circuit is, for example, an FPGA, an ASIC, or the like. The controller 25 executes processing related to the operations of the vehicle 20 while controlling the components of the vehicle 20.

The functions of the vehicle 20 are realized by executing a vehicle program according to the present embodiment by a processor corresponding to the controller 25. That is, the functions of the vehicle 20 are realized by software. The vehicle program causes a computer to execute the operations of the vehicle 20, thereby causing the computer to function as the vehicle 20. That is, the computer functions as the vehicle 20 by executing the operations of the vehicle 20 according to the vehicle program.

Some or all of the functions of the vehicle 20 may be implemented by a dedicated circuit corresponding to the controller 25. That is, some or all of the functions of the vehicle 20 may be realized by hardware.

The controller 25 controls the positioner 22 to acquire positional information on the vehicle 20. The controller 25 controls the communication interface 21 to transmit the acquired positional information on the vehicle 20 to the information processing apparatus 10 via the network 2. The controller 25 may acquire, at established time intervals, the positional information on the vehicle 20 and transmit the acquired positional information on the vehicle 20 to the information processing apparatus 10. The time intervals may be set based on an average speed or the like of the vehicle 20.

<Configuration of Terminal Apparatus>

As illustrated in FIG. 2, each of the terminal apparatuses 30 includes a communication interface 31, a positioner 32, an input interface 33, an output interface 34, a memory 35, and a controller 36.

The communication interface 31 is configured to include at least one communication module for connection to the network 2. The communication module is, for example, a communication module compliant with a mobile communication standard such as LTE, 4G, or 5G. However, the communication module is not limited to this. The communication module may be compliant with any communication standard.

The positioner 32 is capable of acquiring positional information on the terminal apparatus 30. The positioner 32 is configured to include at least one receiving module corresponding to a satellite positioning system. The receiving module is, for example, a receiving module corresponding to the GPS. However, the receiving module is not limited to this. The receiving module may be a receiving module corresponding to any satellite positioning system.

The input interface 33 is capable of accepting an input from the user. The input interface 33 is configured to include at least one interface for input that is capable of accepting an input from the user. The interface for input is, for example, a physical key, a capacitive key, a pointing device, a touch screen integrally provided with a display, a microphone, or the like. However, the interface for input is not limited to this.

The output interface 34 is capable of outputting data. The output interface 34 is configured to include at least one interface for output that is capable of outputting data. The interface for output is, for example, a display, a speaker, or the like. The display is, for example, an LCD, an organic EL display, or the like. However, the interface for output is not limited to this.

The memory 35 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 35 may function as a main memory, an auxiliary memory, or a cache memory. The memory 35 stores data to be used for operations of the terminal apparatus 30 and data obtained by the operations of the terminal apparatus 30.

The controller 36 is configured to include at least one processor, at least one dedicated circuit, or a combination thereof. The processor is, for example, a general purpose processor such as a CPU or a GPU, or a dedicated processor that is dedicated to specific processing The dedicated circuit is, for example, an FPGA, an ASIC, or the like. The controller 36 executes processes related to the operations of the terminal apparatus 30 while controlling the components of the terminal apparatus 30.

The functions of the terminal apparatus 30 are realized by execution of a terminal program according to the present embodiment by a processor corresponding to the controller 36. That is, the functions of the terminal apparatus 30 are realized by software. The terminal program causes a computer to execute the operations of the terminal apparatus 30, thereby causing the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be realized by a dedicated circuit corresponding to the controller 36. That is, some or all of the functions of the terminal apparatus 30 may be realized by hardware.

The controller 36 controls the positioner 32 to acquire positional information on the terminal apparatus 30. The controller 36 controls the communication interface 31 to transmit, to the information processing apparatus 10 via the network 2, the acquired positional information on the terminal apparatus 30, together with identification information on the user. The identification information on the user is information capable of uniquely identifying the user. The controller 36 may acquire, at established time intervals, the positional information on the terminal apparatus 30 and transmit the acquired positional information on the terminal apparatus 30, together with the identification information on the user, to the information processing apparatus 10. The time intervals may be set based on an average speed at which the terminal apparatus 30 moves, or the like.

<Configuration of Output Apparatus>

As illustrated in FIG. 2, each of the output apparatuses 40 includes a communication interface 41, an output interface 42, a memory 43, and a controller 44.

The communication interface 41 is configured to include at least one communication module for connection to the network 2. The communication module is, for example, a communication module compliant with a mobile communication standard such as LTE, 4G, or 5G. However, the communication module is not limited to this. The communication module may be compliant with any communication standard.

The output interface 42 is capable of outputting data. The output interface 42 is configured to include at least one interface for output that is capable of outputting data. The interface for output is, for example, a display, a speaker, or the like. The display is, for example, an LCD, an organic EL display, or the like. In FIG. 1, the output interface 42 is illustrated as a display. However, the interface for output is not limited to this.

The memory 43 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 43 may function as a main memory, an auxiliary memory, or a cache memory. The memory 43 stores data to be used for operations of the output apparatus 40 and data obtained by the operations of the output apparatus 40.

The controller 44 is configured to include at least one processor, at least one dedicated circuit, or a combination thereof. The processor is, for example, a general purpose processor such as a CPU or a GPU, or a dedicated processor that is dedicated to specific processing The dedicated circuit is, for example, an FPGA, an ASIC, or the like. The controller 44 executes processing related to the operations of the output apparatus 40 while controlling the components of the output apparatus 40.

The functions of the output apparatus 40 are realized by execution of an output program according to the present embodiment by a processor corresponding to the controller 44. That is, the functions of the output apparatus 40 are realized by software. The output program causes a computer to execute the operations of the output apparatus 40, thereby causing the computer to function as the output apparatus 40. That is, the computer executes the operations of the output apparatus 40 in accordance with the output program to thereby function as the output apparatus 40.

Some or all of the functions of the output apparatus 40 may be realized by a dedicated circuit corresponding to the controller 44. That is, some or all of the functions of the output apparatus 40 may be realized by hardware.

(Processing of Information Processing System)

The processing of the information processing apparatus 10 will be described below.

<Scheduled Time Acquisition Processing>

The controller 13 acquires information on a scheduled time T1 for loading the article 4 onto the vehicle 20. In the present embodiment, the controller 13 acquires the information on the scheduled time T1 by controlling the communication interface 11 to receive transport information on the article 4 from a terminal apparatus of a manager of the article 4, an external server, or the like via the network 2. For example, in a case in which the article 4 is transported by the vehicle 20 from one factory to another factory in the site, the controller 13 controls the communication interface 11 to receive the transport information on the article 4 from the terminal apparatus of the manager of the article 4. For example, in a case in which the article 4 is an externally produced part and is brought in the site from outside, the controller 13 controls the communication interface 11 to receive the transportation information on the article 4 from the external server. However, the controller 13 may acquire the information on the scheduled time T1 by any method.

The transport information on the article 4 includes, for example, the information on the scheduled time T1 described above, information on the stop 3A at which the article 4 is to be loaded onto the vehicle 20, information on the stop 3B at which the article 4 is to be unloaded from the vehicle 20, information on the size of the article 4, information on the weight of the article 4, and the like. However, the transport information on the article 4 may include any information on transport of the article 4.

Upon receiving the transport information on the article 4, the controller 13 may identify a first stop at which the article 4 is scheduled to be loaded onto the vehicle 20 and a second stop at which the article 4 is scheduled to be unloaded from the vehicle 20. In the present embodiment, the controller 13 identifies the first stop as the stop 3A and identifies the second stop as the stop 3B.

<Predicted Number Acquisition Processing>

Upon acquiring the information on the scheduled time T1, the controller 13 acquires the predicted number of passengers on the vehicle 20 at the scheduled time T1. The controller 13 may acquire the predicted number of passengers on the vehicle 20 at the scheduled time T1, using, as the scheduled time T1, a point of time when users have completed getting on and off the vehicle 20 at the stop 3A, for example, a departure time of the vehicle 20 from the stop 3A. The controller 13 may acquire the predicted number of passengers by any method.

As an example, the controller 13 may acquire the predicted number of passengers on the vehicle 20 at the scheduled time T1, based on information on the past number of passengers on the vehicle 20. When the vehicle 20 circulates the same route on the same operation schedule on weekdays, the number of passengers on the vehicle 20 at the same time during the day can be similar on weekdays, even if the days of the week are different. Hour and minute indicates the hour and minute, such as 8:50 a.m., for example. When the vehicle 20 circulates the same route on the same operation schedule on weekdays and the scheduled time T1 is a time during the day on a weekday, the controller 13 may calculate an average number of passengers on the vehicle 20 at the same hour and minute as the scheduled time T1 over a set time period. The controller 13 may acquire the calculated average number as the predicted number of passengers on the vehicle 20 at the scheduled time T1. The set time period may be based on the amount of information on the past number of passengers on the vehicle 20, or the like. The controller 13 may control the communication interface 11 to receive the information on the past number of passengers on the vehicle 20 from an external server or the like that manages the number of passengers on the vehicle 20.

As another example, the controller 13 may acquire the predicted number of passengers on the vehicle 20 at the scheduled time T1, based on operation information on the factories in the site. The operation information on the factories may be information indicating operation statuses of the factories. The operation information on the factories includes, for example, information on production lines that are scheduled to be operated and/or information on production lines that have been operated in the past. The information on the production lines includes, for example, a start time of operation of each production line, an end time of operation of each production line, and the type of each production line. The controller 13 may control the communication interface 11 to receive the operation information on the factories from an external server or the like that manages the production lines of the factories via the network 2. The controller 13 may use operation information on a factory to and from which users who get on and off the vehicle 20 at the stop 3A are supposed to commute. For example, the controller 13 may use operation information on a factory, of the factories in the site, that is located within a set range from the stop 3A, or use operation information on the closest factory to the stop 3A. The set range may be based on a travel distance by foot that is acceptable by the users. The controller 13 may predict the predicted number of passengers on the vehicle 20 at the scheduled time T1, by predicting the number of users getting on and off the vehicle 20 at the stop 3A at the scheduled time T1 based on the operation information on the factories. The controller 13 may acquire the predicted number of passengers on the vehicle 20 at the scheduled time T1, according to a prediction result on the number of users getting on and off the vehicle 20 at the stop 3A at the scheduled time T1 and the past number of passengers on the vehicle 20.

As yet another example, the controller 13 may acquire the predicted number of passengers on the vehicle 20 at the scheduled time T1, based on attendance information on workers in the factories. The attendance information on workers may be information indicating an attendance status of each worker. The attendance information on workers includes, for example, information on each worker's scheduled arrival time, scheduled departure time, past arrival time, and past departure time, the type of the production line on which each worker is scheduled to work, and the type of the production line on which each worker has worked in the past. The controller 13 may control the communication interface 11 to receive the attendance information on workers in the factories, from an external server or the like that manages attendance via the network 2. The controller 13 may use attendance information on workers in a factory to and from which users who get on and off the vehicle 20 at the stop 3A are supposed to commute. For example, the controller 13 may use attendance information on workers in a factory, of the factories in the site, that is located within the above set range from the stop 3A, or use attendance information on workers in the closest factory to the stop 3A. The controller 13 may predict the predicted number of passengers on the vehicle 20 at the scheduled time T1, by predicting the number of users getting on and off the vehicle 20 at the stop 3A at the scheduled time T1 based on the attendance information on workers at the factories. The controller 13 may acquire the predicted number of passengers on the vehicle 20 at the scheduled time T1, according to a prediction result on the number of users getting on and off the vehicle 20 at the stop 3A at the scheduled time T1 and the past number of passengers on the vehicle 20.

<First and Second Users Determination Processing>

At a set time T2 before the scheduled time T1, the controller 13 identifies users riding on the vehicle 20. The date of the set time T2 may be the same as the date of the scheduled time T1. The set time T2 may be based on the operation schedule of the vehicle 20. For example, the set time T2 may be a departure or arrival time of the vehicle 20 at any stop at which the vehicle 20 arrives before the stop 3A.

As an example, the controller 13 may identify users riding on the vehicle 20, based on the positional information on the vehicle 20, the positional information on the terminal apparatuses 30, and the identification information on the users. For example, the controller 13 identifies terminal apparatuses 30 moving with the vehicle 20, based on the positional information on the vehicle 20 and the positional information on the terminal apparatuses 30, which are received sequentially. The controller 13 identifies users riding on the vehicle 20 by acquiring identification information on users of the identified terminal apparatuses 30.

As another example, the controller 13 may identify users riding on the vehicle 20 by receiving, from the vehicle 20, identification information on users of terminal apparatuses 30. In this case, in the vehicle 20, the controller 25 controls the communication interface 21 to receive, by short-range wireless communication, identification information on users of terminal apparatuses 30 present within a preset communication range from the communication interface 21. This communication range may be set based on the size of the vehicle 20. This communication range is, for example, several meters. When identification information on users of the same terminal apparatuses 30 continues to be received beyond set time, the controller 25 controls the communication interface 21 to transmit the identification information on the users of the terminal apparatuses 30 to the information processing apparatus 10 via the network 2. The set time may be in seconds or minutes. The controller 13 controls the communication interface 11 to receive the identification information on the users of the terminal apparatuses 30 from the vehicle 20 via the network 2. The controller 13 identifies users riding on the vehicle 20 by receiving the identification information on the users of the terminal apparatuses 30.

When the users riding on the vehicle 20 are identified, the controller 13 selects a first user candidate and a second user candidate, from among the identified users riding on the vehicle 20. The first user candidate is a candidate for a first user. The first user is a user who is scheduled to load the article 4 onto the vehicle 20 at the stop 3A. The first user candidate is requested to become the first user, as described below. The second user candidate is a candidate for a second user. The second user is a user who is scheduled to unload the article 4 from the vehicle 20 at the stop 3B. The second user candidate is requested to become the second user, as described below. The first and second user candidates may be the same user or different users.

As an example, the controller 13 may select the first and second user candidates based on the weight of the article 4 and ages of the users. In this case, the memory 12 may store, in advance, data on ages of the users of the terminal apparatuses 30, in association with the identification information on the users of the terminal apparatuses 30. When the weight of the article 4 exceeds a weight threshold, the controller 13 refers to the memory 12 and preferentially selects users with younger ages, as the first and second user candidates. The weight threshold may be set based on physical force or other factors of general users. The controller 13 may select a plurality of first user candidates and a plurality of second user candidates, according to the weight or size of the article 4.

As another example, the controller 13 may select the first and second user candidates, based on the weight of the article 4 and fatigue levels of the users. The fatigue level of a user is an indicator indicating the degree of fatigue of the user. The higher the fatigue level of a user, the greater the degree of fatigue of the user. The controller 13 may estimate the fatigue level of a user based on attendance information on the user. The controller 13 may acquire information on the previous day's overtime hours from the attendance information on the user, and estimate that the longer the overtime hours, the higher the fatigue level of the user. The controller 13 may also identify the type of a production line on which the user has worked from the attendance information on the user. When it is determined that heavy lifting is required on the identified production line, the controller 13 may estimate that the fatigue level of the user is higher than when no heavy lifting is required. The controller 13 preferentially selects users with low fatigue levels as the first and second user candidates, from among the users riding on the vehicle 20. The controller 13 may select a plurality of first user candidates and a plurality of second user candidates, according to the weight or size of the article 4.

As yet another example, the controller 13 may select, as the first user candidate, a user whose destination is the stop 3A or a user whose destination is closer to the stop 3A than the other users. The controller 13 may also select, as the second user candidate, a user whose destination is the stop 3B or a user whose destination is closer to the stop 3B than the other users. The controller 13 may identify destinations of the users by any method.

When the first user candidate is selected, the controller 13 controls the communication interface 11 to transmit a first request notification to the terminal apparatus 30 of the first user candidate via the network 2. The first request notification is a notification indicating a request to load the article 4 onto the vehicle 20 at the stop 3A. In the terminal apparatus 30 of the first user candidate, when the communication interface 31 receives the first request notification from the information processing apparatus 10 via the network 2, the controller 36 controls the output interface 34 to output information indicated by the first request notification. For example, the controller 36 controls the output interface 34 to output the information indicated by the first request notification as an image on a display of the output interface 34, or as a sound from a speaker of the output interface 34. By checking the information output from the output interface 34, the first user candidate can know that he/she has been requested to load the article 4 onto the vehicle 20 at the stop 3A. The first user candidate considers whether to accept the request to load the article 4 onto the vehicle 20 at the stop 3A. When the first user candidate decides to accept the request, he/she enters, from the input interface 33, an input to accept the request. When the first user candidate decides not to accept the request, he/she enters an input to decline the request from the input interface 33. In the terminal apparatus 30 of the first user candidate, when the input interface 33 has received the input to accept the request, the controller 36 controls the communication interface 31 to transmit a signal to accept the request to the information processing apparatus 10 via the network 2. In the terminal apparatus 30 of the first user candidate, when the input interface 33 has received the input to decline the request, the controller 36 controls the communication interface 31 to transmit a signal to decline the request to the information processing apparatus 10 via the network 2.

When the second user candidate is selected, the controller 13 controls the communication interface 11 to transmit a second request notification to the terminal apparatus 30 of the second user candidate via the network 2. The second request notification is a notification indicating a request to unload the article 4 from the vehicle 20 at the stop 3B. In the terminal apparatus 30 of the second user candidate, when the communication interface 31 receives the second request notification from the information processing apparatus 10 via the network 2, the controller 36 controls the output interface 34 to output information indicated by the second request notification. For example, the controller 36 controls the output interface 34 to output the information indicated by the second request notification as an image on a display of the output interface 34, or as a sound from a speaker of the output interface 34. In the same or similar manner as the first user candidate, the second user candidate enters, from the input interface 33, an input to accept or decline the request. In the terminal apparatus 30 of the second user candidate, when the input interface 33 has received the input to accept the request, the controller 36 controls the communication interface 31 to transmit a signal to accept the request to the information processing apparatus 10 via the network 2. In the terminal apparatus 30 of the second user candidate, when the input interface 33 has received the input to decline the request, the controller 36 controls the communication interface 31 to transmit a signal to decline the request to the information processing apparatus 10 via the network 2.

The controller 13 controls the communication interface 11 to receive the signal to accept the request or the signal to decline the request, from the terminal apparatus 30 of the first user candidate via the network 2. When the signal to accept the request is received, the controller 13 determines the first user candidate as the first user. When the signal to decline the request is received, the controller 13 selects a new first user candidate, and controls the communication interface 11 to transmit the first request notification to the terminal apparatus 30 of the selected new first user candidate.

The controller 13 controls the communication interface 11 to receive the signal to accept the request or the signal to decline the request, from the terminal apparatus 30 of the second user candidate via the network 2. When the signal to accept the request is received, the controller 13 determines the second user candidate as the second user. When the signal to decline the request is received, the controller 13 selects a new second user candidate, and controls the communication interface 11 to transmit the second request notification to the terminal apparatus 30 of the selected new second user candidate.

Upon determining the first and second users, the controller 13 may determine to provide each of the first and second users with an incentive. The incentive may be provided, for example, by returning to each of the users a fare of the vehicle 20. The incentive may be provided, for example, as a point that can be used for payment of the fare of the vehicle 20. The incentive may be provided as electronic money. The incentive may be provided as a point that can be exchanged for valuables or a paid service. The provision of the incentive increases the likelihood that the first and second user candidates will actively accept the requests. According to this configuration, the first and second users can be smoothly determined.

The controller 13 may determine to provide the first user with the incentive when the controller 13 identifies that the first user has actually loaded the article 4 onto the vehicle 20. The controller 13 may identify that the first user has actually loaded the article 4 onto the vehicle 20 when the communication interface 11 receives, from the terminal apparatus of the manager of the article 4, the terminal apparatus 30 of the first user, or the like via the network 2, a report notification reporting that the first user has loaded the article 4 onto the vehicle 20. According to this configuration, the first user can more reliably load the article 4 onto the vehicle 20.

The controller 13 may determine to provide the second user with the incentive when the controller 13 identifies that the second user has actually unloaded the article 4 from the vehicle 20. The controller 13 may identify that the second user has actually unloaded the article 4 from the vehicle 20 when the communication interface 11 receives, from the terminal apparatus of the manager of the article 4, the terminal apparatus 30 of the second user, or the like via the network 2, a report notification reporting that the second user has unloaded the article 4 from the vehicle 20. According to this configuration, the second user can more reliably unload the article 4 from the vehicle 20.

<Determination Processing>

The controller 13 determines whether the vehicle 20 has space for the article 4 at the scheduled time T1. For example, the controller 13 determines whether the vehicle 20 has space for the article 4 at the scheduled time T1, based on the predicted number of passengers on the vehicle 20 at the scheduled time T1, information on volume per passenger on the vehicle 20, and information on the size of the article 4.

When it is determined that the vehicle 20 does not have the space for the article 4 at the scheduled time T1, the controller 13 may perform any processing to secure the space. The following is an example of the processing to secure the space.

<Third User Determination Processing>

When it is determined that the vehicle 20 does not have the space for the article 4 at the scheduled time T1, the controller 13 selects a third user candidate, from among the users riding on the vehicle 20. The third user candidate is a candidate for a third user. The third user is a user who is scheduled to get off the vehicle 20 before the vehicle 20 arrives at the stop 3A. The third user candidate is requested to become the third user, as described below. By letting the third user get off the vehicle 20 before the vehicle 20 arrives at the stop 3A, the space for the article 4 can be secured on the vehicle 20 at the scheduled time T1. The controller 13 selects a user, other than the first and second users, as the third user candidate. Depending on the size of the article 4, the controller 13 may select a plurality of third user candidates.

As an example, the controller 13 may assign, to the users riding on the vehicle 20, priorities to request to get off the vehicle 20. The controller 13 preferentially selects a user with the highest priority as the third user candidate. The controller 13 may assign the priorities by any method. For example, the controller 13 may assign the priorities to the users based on the fatigue levels of the users. The controller 13 may estimate the fatigue level of each user, as described above. The higher the estimated fatigue level, the controller 13 may give a lower priority to the user. According to this configuration, it is possible to request a user with a low fatigue level to get off the vehicle 20.

When the third user candidate is selected, the controller 13 controls the communication interface 11 to transmit a third request notification to the terminal apparatus 30 of the third user candidate via the network 2. The third request notification is a notification indicating a request to get off the vehicle 20 before the vehicle 20 arrives at the first stop, i.e., the stop 3A at which the article 4 is scheduled to be loaded onto the vehicle 20. In the terminal apparatus 30 of the third user candidate, when the communication interface 31 receives the third request notification from the information processing apparatus 10 via the network 2, the controller 36 controls the output interface 34 to output information indicated by the third request notification. For example, the controller 36 controls the output interface 34 to output the information indicated by the third request notification as an image on a display of the output interface 34 or as a sound from a speaker of the output interface 34. By checking the information output from the output interface 34, the third user candidate can know that he/she has been requested to get off the vehicle 20 before the vehicle 20 arrives at the stop 3A. When the third user candidate decides to accept the request, he/she enters, from the input interface 33, an input to accept the request. When the third user candidate decides not to accept the request, he/she enters, from the input interface 33, an input to decline the request. In the terminal apparatus 30 of the third user candidate, when the input interface 33 has received the input to accept the request, the controller 36 controls the communication interface 31 to transmit a signal to accept the request to the information processing apparatus 10 via the network 2. In the terminal apparatus 30 of the third user candidate, when the input interface 33 has received the input to decline the request, the controller 36 controls the communication interface 31 to transmit a signal to decline the request to the information processing apparatus 10 via the network 2.

The controller 13 controls the communication interface 11 to receive the signal to accept the request or the signal to decline the request, from the terminal apparatus 30 of the third user candidate via the network 2. When the signal to accept the request is received, the controller 13 determines the third user candidate as the third user. When the signal to decline the request is received, the controller 13 selects a new third user candidate, and controls the communication interface 11 to transmit the third request notification to the terminal apparatus 30 of the selected new third user candidate.

The controller 13 may determine to provide the third user with the incentive described above. The provision of the incentive increases the likelihood that the third user candidate will actively accept the request. According to this configuration, the third user can be smoothly determined.

The controller 13 may determine to provide the third user with the incentive when the controller 13 identifies that the third user has actually gotten off the vehicle 20 before arrival at the stop 3A. The controller 13 may identify that the third user has actually gotten off the vehicle 20 before arrival at the stop 3A, when the communication interface 11 receives, from the vehicle 20, the terminal apparatus 30 of the third user, or the like via the network 2, a signal indicating that the third user has gotten off the vehicle 20 before arrival at the stop 3A. According to this configuration, the third user can more reliably get off the vehicle 20 before arrival at the stop 3A.

The controller 13 may select two or more third user candidates and determine two or more third users. When there is only one user getting off the vehicle 20, the user may be hesitant to get off the vehicle 20 and, as a result, may stop getting off the vehicle 20. By determining two or more third users, the third users can more reliably get off the vehicle 20.

<Notification Processing>

When it is determined that the vehicle 20 does not have the space for the article 4 at the scheduled time T1, the controller 13 may perform notification processing, in addition to or instead of the third user determination processing. The notification processing is processing of notifying users of information via the output apparatuses 40 at the stops or the vehicle 20.

As an example, the controller 13 controls the communication interface 11 to transmit a first notification to the output apparatus 40 at any stop or the vehicle 20 via the network 2. The first notification indicates that riding on the vehicle 20 is possible up to the first stop, i.e., the stop 3A at which the article 4 is scheduled to be loaded onto the vehicle 20, or riding on the vehicle 20 is restricted after the stop 3A. The controller 13 may transmit the first notification to the output apparatus 40 at any stop at which the vehicle 20 arrives before the stop 3A.

In a case in which the first notification is transmitted to the output apparatus 40, the controller 44 controls the communication interface 41 to receive the first notification from the information processing apparatus 10 via the network 2. When the first notification is received, the controller 44 controls the output interface 42 to output information indicated by the first notification. For example, the controller 44 controls the output interface 42 to output the information indicated by the first notification as an image on a display of the output interface 42 or as a sound from a speaker of the output interface 42. By outputting the information indicated by the first notification from the output interface 42, users waiting at the stop can know that riding on the vehicle 20 is possible up to the stop 3A, or that riding on the vehicle 20 is restricted after the stop 3A. Users whose destinations are stops beyond the stop 3A can consider using other transportation means except the vehicle 20.

In a case in which the first notification is transmitted to the vehicle 20, in the vehicle 20, the controller 25 controls the communication interface 21 to receive the first notification from the information processing apparatus 10 via the network 2. When the first notification is received, the controller 25 controls the output interface 23 to output information indicated by the first notification. For example, the controller 25 controls the output interface 23 to output the information indicated by the first notification as an image on a display of the output interface 23 or as a sound from a speaker of the output interface 23. By outputting the information indicated by the first notification from the output interface 23, the users riding on the vehicle 20 can know that riding on the vehicle 20 is possible up to the stop 3A, or that riding on the vehicle 20 is restricted after the stop 3A. The users can consider getting off the vehicle 20 before the vehicle 20 arrives at the stop 3A.

As another example, the controller 13 controls the communication interface 11 to transmit a second notification to the output apparatus 40 at any stop or the vehicle 20 via the network 2. The second notification indicates that the number of passengers in the vehicle 20 is limited in a section from the first stop, i.e., the stop 3A at which the article 4 is scheduled to be loaded onto the vehicle 20, to the second stop, i.e., the stop 3B at which the article 4 is scheduled to be unloaded from the vehicle 20. The controller 13 may control the communication interface 11 to transmit the second notification to the output apparatus 40 at any stop at which the vehicle 20 arrives before the stop 3A, or the output apparatus 40 at any stop between the stop 3A and the stop 3B on the route that the vehicle 20 circulates. The second notification may further indicate information on the maximum number of passengers that can be accommodated in the vehicle 20. In this case, the controller 13 may acquire the maximum number of passengers that can be accommodated in the vehicle 20 with the space for the article 4 secured on the vehicle 20.

In a case in which the second notification is transmitted to the output apparatus 40, the controller 44 controls the communication interface 41 to receive the second notification from the information processing apparatus 10 via the network 2. When the second notification is received, the controller 44 controls the output interface 42 to output information indicated by the second notification. For example, the controller 44 controls the output interface 42 to output the information indicated by the second notification as an image on a display of the output interface 42 or as a sound from a speaker of the output interface 42. By outputting the information indicated by the second notification from the output interface 42, users waiting at the stop can know that the number of passengers on the vehicle 20 is limited in the section from the stop 3A to the stop 3B. Users whose destinations are any stops in the section from the stop 3A to the stop 3B can consider using other transportation means except the vehicle 20.

In a case in which the second notification is transmitted to the vehicle 20, the controller 25 controls the communication interface 21 to receive the second notification from the information processing apparatus 10 via the network 2. When the second notification is received, the controller 25 controls the output interface 23 to output information indicated by the second notification. For example, the controller 25 controls the output interface 23 to output the information indicated by the second notification as an image on a display of the output interface 23, or as a sound from a speaker of the output interface 23. By outputting the information indicated by the second notification from the output interface 23, the users riding on the vehicle 20 can know that the number of passengers on the vehicle 20 is limited in the section from the stop 3A to the stop 3B. The users can consider getting off the vehicle 20 before the vehicle 20 arrives at the stop 3A.

(Operations of Information Processing System)

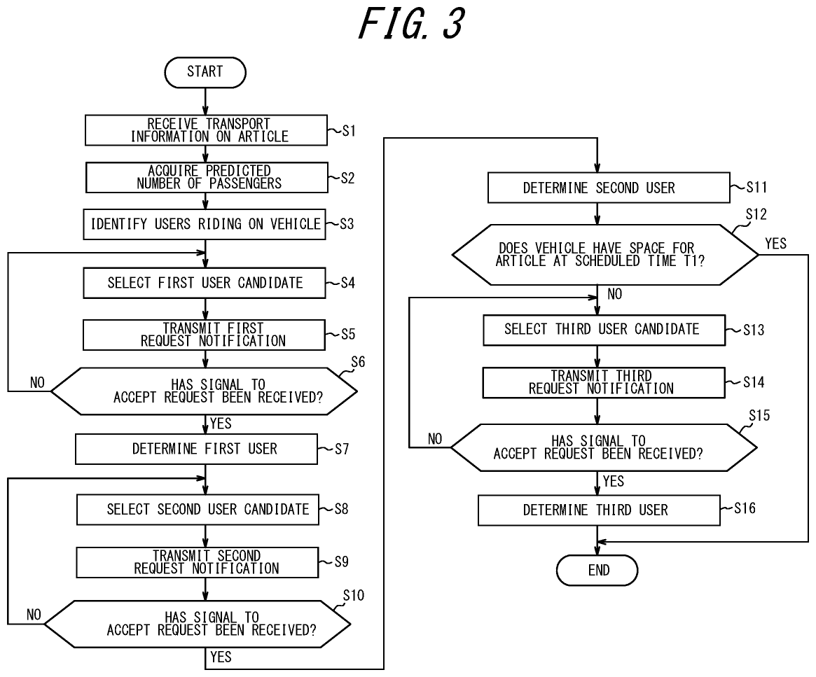

FIG. 3 is a flowchart illustrating operations of the information processing apparatus 10 illustrated in FIG. 2. The operations may correspond to an example of an information processing method according to the present embodiment. For example, when transport information on an article 4 is transmitted to the information processing apparatus 10, the controller 13 starts the processing of step S1.

The controller 13 controls the communication interface 11 to receive the transport information on the article 4 from a terminal apparatus of a manager of the article 4, an external server, or the like via the network 2 (step S1). The controller 13 acquires the predicted number of passengers on the vehicle 20 at a scheduled time T1 (step S2). At a set time T2 before the scheduled time T1, the controller 13 identifies users riding on the vehicle 20 (step S3).

The controller 13 selects a first user candidate, from among the users riding on the vehicle 20 identified in the processing of step S3 (step S4). The controller 13 controls the communication interface 11 to transmit the first request notification to the terminal apparatus 30 of the first user candidate via the network 2 (step S5). The controller 13 determines whether the communication interface 11 has received a signal to accept the request, from the terminal apparatus 30 of the first user candidate via the network 2 (step S6). When it is determined that a signal to decline the request has been received (step S6: NO), the controller 13 returns to the processing of step S4. When it is determined that the signal to accept the request has been received (step S6: YES), the controller 13 proceeds to the processing of step S7. In the processing of step S7, the controller 13 determines the first user candidate selected in the processing of step S4 as a first user.

In the processing of step S8, the controller 13 selects a second user candidate, from among the users on the vehicle 20 identified in the processing of step S3. The controller 13 controls the communication interface 11 to transmit the second request notification to the terminal apparatus 30 of the second user candidate via the network 2 (step S9). The controller 13 determines whether the communication interface 11 has received a signal to accept the request, from the terminal apparatus 30 of the second user candidate via the network 2 (step S10). When it is determined that a signal to decline the request has been received (step S10: NO), the controller 13 returns to the processing of step S8. When it is determined that the signal to accept the request has been received (step S10: YES), the controller 13 proceeds to the processing of step S11. In the processing of step S11, the controller 13 determines the second user candidate selected in the processing of step S8 as a second user.

In the processing of step S12, the controller 13 determines whether the vehicle 20 has space for the article 4 at the scheduled time T1. When it is determined that the vehicle 20 has the space for the article 4 at the scheduled time T1 (step S12: YES), the controller 13 ends the processing. When it is determined that the vehicle 20 does not have the space for the article 4 at the scheduled time T1 (step S12: NO), the controller 13 proceeds to the processing of step S13.

In the processing of step S13, the controller 13 selects a third user candidate, from among the users riding on the vehicle 20 identified in the processing of step S3. The controller 13 controls the communication interface 11 to transmit the third request notification to the terminal apparatus 30 of the third user candidate via the network 2 (step S14). The controller 13 determines whether the communication interface 11 has received a signal to accept the request, from the terminal apparatus 30 of the third user candidate via the network 2 (step S15). When it is determined that a signal to decline the request has been received (step S15: NO), the controller 13 returns to the processing of step S13. When it is determined that the signal to accept the request has been received (step S15: YES), the controller 13 proceeds to the processing of step S16. In the processing of step S16, the controller 13 determines the third user candidate selected in the processing of step S13 as a third user.

In the information processing apparatus 10, as described above, the controller 13 determines whether the vehicle 20 has the space for the article 4 at the scheduled time T1. With this configuration, when it is determined that the vehicle 20 does not have the space for the article 4, the controller 13 can perform any processing to secure the space for the article 4 on the vehicle 20. By performing the processing to secure the space for the article 4 on the vehicle 20, the article 4 can be transported smoothly by the vehicle 20. Therefore, according to the present embodiment, technology for efficient transport of the article 4 can be provided.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, when a user heading for the stop 3A or 3B is identified, the controller 13 of the information processing apparatus 10 may control the communication interface 11 to transmit the first or second notification to the terminal apparatus 30 of the user via the network 2. The controller 13 may control the communication interface 11 to receive user schedule information via the network 2 from an external server or the like that manages schedules of users. The controller 13 may identify the user heading for the stop 3A or 3B by analyzing the received user schedule information. In the terminal apparatus 30 of the user heading for the stop 3A or 3B, when the communication interface 31 receives the first or second notification from the information processing apparatus 10 via the network 2, the controller 36 may control the output interface 34 to output the information indicated by the first or second notification. For example, the controller 36 controls the output interface 34 to output the information indicated by the first or second notification as an image on a display of the output interface 34 or as a sound from a speaker of the output interface 34.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller configured to:
acquire information on a scheduled time for loading an article onto a vehicle;
acquire a predicted number of passengers on the vehicle at the scheduled time; and
determine whether the vehicle has space for the article at the scheduled time.

2. The information processing apparatus according to claim 1, wherein the controller is configured to acquire the predicted number of passengers on the vehicle based on information on a number of passengers on the vehicle in a past.

3. The information processing apparatus according to claim 1, wherein
the vehicle travels within a predetermined site,
the site has a factory, and
the controller is configured to acquire the predicted number of passengers on the vehicle based on operation information on the factory.

4. The information processing apparatus according to claim 1, wherein
the vehicle travels within a predetermined site,
the site has a factory, and
the controller is configured to acquire the predicted number of passengers on the vehicle based on attendance information on workers in the factory.

5. The information processing apparatus according to claim 1, wherein the controller is configured to:
identify users riding on the vehicle at a set time before the scheduled time; and
determine, from among the identified users riding on the vehicle, a first user who is scheduled to load the article onto the vehicle and a second user who is scheduled to unload the article from the vehicle.

6. The information processing apparatus according to claim 5, further comprising a communication interface,
wherein the controller is configured to:
select, from among the identified users riding on the vehicle, a first user candidate being a candidate for the first user and a second user candidate being a candidate for the second user;
control the communication interface to transmit, to a terminal apparatus of the first user candidate, a first request notification indicating a request to load the article onto the vehicle;
control the communication interface to transmit, to a terminal apparatus of the second user candidate, a second request notification indicating a request to unload the article from the vehicle;
determine the first user candidate as the first user when the communication interface receives, from the terminal apparatus of the first user candidate, a signal to accept the request; and
determine the second user candidate as the second user when the communication interface receives, from the terminal apparatus of the second user candidate, a signal to accept the request.

7. The information processing apparatus according to claim 6, wherein when the communication interface receives, from the terminal apparatus of the first user candidate, a signal to decline the request, the controller selects a new first user candidate and controls the communication interface to transmit the first request notification to a terminal apparatus of the selected new first user candidate.

8. The information processing apparatus according to claim 6, wherein when the communication interface receives, from the terminal apparatus of the second user candidate, a signal to decline the request, the controller selects a new second user candidate and controls the communication interface to transmit the second request notification to a terminal apparatus of the selected new second user candidate.

9. The information processing apparatus according to claim 6, wherein the controller is configured to select the first and second user candidates based on a weight of the article and ages of the users.

10. The information processing apparatus according to claim 6, wherein the controller is configured to select the first and second user candidates based on a weight of the article and fatigue levels of the users.

11. The information processing apparatus according to claim 5, wherein
when it is determined that the vehicle does not have the space for the article at the scheduled time,
the controller determines, from among the identified users riding on the vehicle other than the first and second users, a third user who is scheduled to get off the vehicle before the vehicle arrives at a first stop, and
the first stop is a stop at which the article is scheduled to be loaded onto the vehicle.

12. The information processing apparatus according to claim 11, further comprising a communication interface,
wherein the controller is configured to:
assign, to the identified users riding on the vehicle, priorities to request to get off the vehicle;
preferentially select a user with a high priority as a third user candidate being a candidate for the third user;
control the communication interface to transmit, to a terminal apparatus of the third user candidate, a third request notification indicating a request to get off the vehicle before the vehicle arrives at the first stop; and
determine the third user candidate as the third user when the communication interface receives, from the terminal apparatus of the third user candidate, a signal to accept the request.

13. The information processing apparatus according to claim 12, wherein when the communication interface receives, from the terminal apparatus of the third user candidate, a signal to decline the request, the controller selects a new third user candidate and controls the communication interface to transmit the third request notification to a terminal apparatus of the selected new third user candidate.

14. The information processing apparatus according to claim 12, wherein the controller assigns the priorities to the users, based on fatigue levels of the users.

15. The information processing apparatus according to claim 11, wherein the controller is configured to determine to provide the third user with an incentive.

16. The information processing apparatus according to claim 5, wherein the controller is configured to determine to provide each of the first and second users with an incentive.

17. The information processing apparatus according to claim 1, further comprising a communication interface,
wherein when it is determined that the vehicle does not have the space for the article at the scheduled time,
the controller controls the communication interface to transmit, to an output apparatus at a stop or the vehicle, a first notification indicating that riding on the vehicle is possible up to a first stop or riding on the vehicle is restricted after the first stop, and
the first stop is a stop at which the article is scheduled to be loaded onto the vehicle.

18. The information processing apparatus according to claim 1, further comprising a communication interface,
wherein when it is determined that the vehicle does not have the space for the article at the scheduled time,
the controller controls the communication interface to transmit, to an output apparatus at a stop or the vehicle, a second notification indicating that a number of passengers on the vehicle is limited in a section from a first stop to a second stop,
the first stop is a stop at which the article is scheduled to be loaded onto the vehicle, and
the second stop is a stop at which the article is scheduled to be unloaded from the vehicle.

19. The information processing apparatus according to claim 18, wherein the controller is configured to:
acquire a maximum number of passengers that can be accommodated in the vehicle with the space secured; and
the second notification further indicates information on the maximum number.

20. An information processing method comprising:
acquiring information on a scheduled time for loading an article onto a vehicle;
acquiring a predicted number of passengers on the vehicle at the scheduled time; and
determining whether the vehicle has space for the article at the scheduled time.
